(19) United States
(12) Patent Application Publication
(10) Pub. No.: US 2007/0064098 A1
(43) Pub. Date: Mar. 22, 2007

(54) Systems and methods for 3D rendering

(75) Inventor: Bao O. Tran, San Jose, CA (US)

Correspondence Address: TRAN & ASSOCIATES, 6768 MEADOW VISTA CT., SAN JOSE, CA, 95135, US

(73) Assignee: AVAILABLE FOR LICENSING

(21) Appl. No.: 11/230,237

(22) Filed: Sep. 19, 2005

(51) Int. Cl. H04N 13/00

(52) U.S. Cl. 348/43

(57) ABSTRACT

Systems and methods are disclosed for performing three-dimensional video conferencing by capturing one or more registration marks; capturing a plurality of views of a scene; transmitting each view in a separate data stream to a remote location; receiving each data stream at the remote location and generating a plurality of images from the data streams; aligning one or more display planes in accordance with the one or more registration marks; and projecting the plurality of images onto one or more aligned display planes to show the 3D view of the scene at the remote location.

### BACKGROUND

The present invention relates generally to 3D rendering.

With the continuously increasing demand for improved electronic imaging displays, and with the increasing bandwidth of computers, several 3D imaging display methods have been suggested, including computer graphics, vibrating or rotating screens, and split images.

Computer graphics using 3D animation give the impression of 3D information by shifting and/or rotating motion, and therefore, they have two basic drawbacks: first, a real, physiological 3D perception is not possible, and second, this method requires active intervention during perception, reducing attention and/or intervention for other actions.

Vibrating or rotating screen displays belong to another class of more recent, real depth imaging displays wherein a volume 3D image is created by lateral or rotational volume-sweeping of a 2D illuminated screen or disk.

Split image display refers to a relatively new method of 3D imaging, wherein an illusion of depth is created by projecting to the viewer's eye, via Fresnel lenses, two pseudoscopic images of two different focal lengths, i.e., a foreground image and a background image. The two different focal contents force the viewer to constantly refocus his eyes, thereby creating an eye accommodation and convergence effect. Static and motion parallax also exist with this method.

In two different attempts to achieve real depth, or volumetric, 3D displays without referring to mechanical volume sweeping, the use of multi-layered, stacked 2D sliced images or image contours has been proposed. The first proposal stacks two types of 2D panels: namely, gas discharge, or plasma, panels on the one hand, and liquid vapor devices on the other. The second proposal, as described in U.S. Pat. No. 5,745,197, teaches the use of stacked, planar, light-absorbing elements consisting of conventional LCD panels sandwiched between polarizers and quarter-wave plates. For practical reasons, LCD devices may be divided into three classes: (a) devices including conventional pairs of polarizers, (b) devices including one single polarizer, and (c) polarizer-free devices. The reason for this division lies in the fact that polarizers absorb an important part, over 50%, of the display illumination. Therefore, conventional LCD devices, as taught by said patent, are disadvantageous because of the necessity to introduce additional elements such as polarizers, which significantly reduce the brightness, and as a consequence the number of stacked layers, or depth, in a device. The reduced brightness necessitates increased lamp power, which in turn increases power consumption and heat dissipation.

U.S. Pat. No. 6,721,023 provides a multi-layered imaging device for three-dimensional image display, including a plurality of two-dimensional layers superposed in the third dimension, each of the layers having two major surfaces and at least one peripheral edge, the layers being made of a material selected from the group of non-conventional, polarizer-free liquid crystal materials including polymer-dispersed liquid crystals (PDLC) and derivatives and combinations thereof, wherein the exposure of at least one of the layers to illumination allows the transmission of light.

U.S. Pat. No. 6,831,678 discloses a video display for displaying a large image to an observer, comprising a screen for displaying patterns, the screen being formed of a plurality of separate areas each capable of receiving a segment of a pattern the segments collectively forming a complete frame of a pattern; projection means for projecting a segment of a pattern to each separate area of the screen in sequence; means for receiving each segment of a pattern and forming a complete frame; and means for illuminating the screen with collimated light to display a large area display.

### SUMMARY

Systems and methods are disclosed for performing three-dimensional video conferencing by capturing one or more registration marks; capturing a plurality of views of a scene; transmitting each view in a separate data stream to a remote location; receiving each data stream at the remote location and generating a plurality of images from the data streams; aligning one or more display planes in accordance with the one or more registration marks; and projecting the plurality of images onto one or more aligned display planes to show the 3D view of the scene at the remote location.

Advantages of the system may include one or more of the following. The system provides a viewer with a three-dimensional representation of a scene (or an object), using two or more, two-dimensional representations of the scene. The two-dimensional representations of the scene are taken from slightly different angles. One or more binocular views of a scene are provided to the viewer. The system provides a full-parallax view that accurately simulates depth perception irrespective of the viewer's motion, as it would exist when the viewer observes a real scene.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 illustrates an exemplary process to provide 3D imaging.

FIG. 2 shows an exemplary system for displaying 3D views.

FIG. 3 shows an exemplary display with a plurality of transparent retro-reflective layers angularly interspersed in a single screen.

FIG. 4 is an illustration of a web-conferencing system suitable for use with the present invention.

### DETAILED DESCRIPTION OF THE SPECIFIC EMBODIMENTS

The present invention is described in terms of examples discussed below. This is for convenience only and is not intended to limit the application of the present invention. In fact, after reading the following description, it will be apparent to one skilled in the relevant art how to implement the present invention in alternative embodiments.

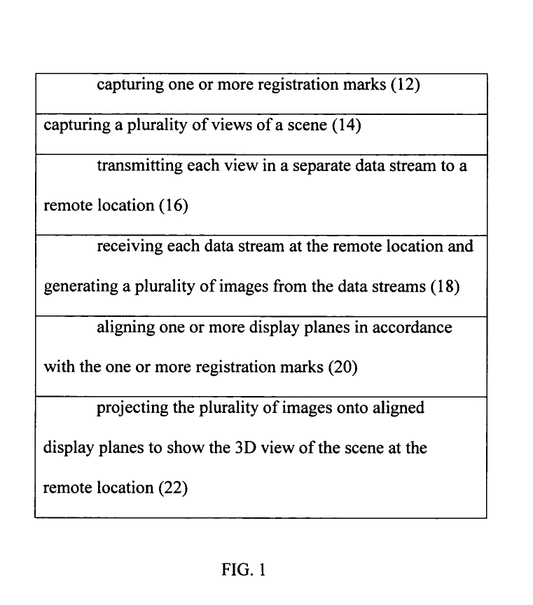

FIG. 1 shows an exemplary process for displaying 3D views. First, the process captures one or more registration marks (12). The registration marks are captured using the camera, and during initialization, the registration marks are displayed on a display device at the remote end and the remote display device can be calibrated based on the registration marks. After calibration data has been captured, the system captures a plurality of views of a scene (14). A high speed network is used to transmit each view in a separate data stream to a remote location (16). Each view can also be compressed. Next, the system receives each data stream at the remote location and generates a plurality of images from the data streams (18). The system aligns one or more display planes in accordance with the one or more registration marks (20), and then projects the plurality of images onto one or more aligned display planes so that a viewer's right and left eyes receive images from adjacent cameras to show stereoscopic 3D view of the scene at the remote location (22). 3D effects are achieved by showing slightly different images captured by spatially related such as nearby cameras to each eye.

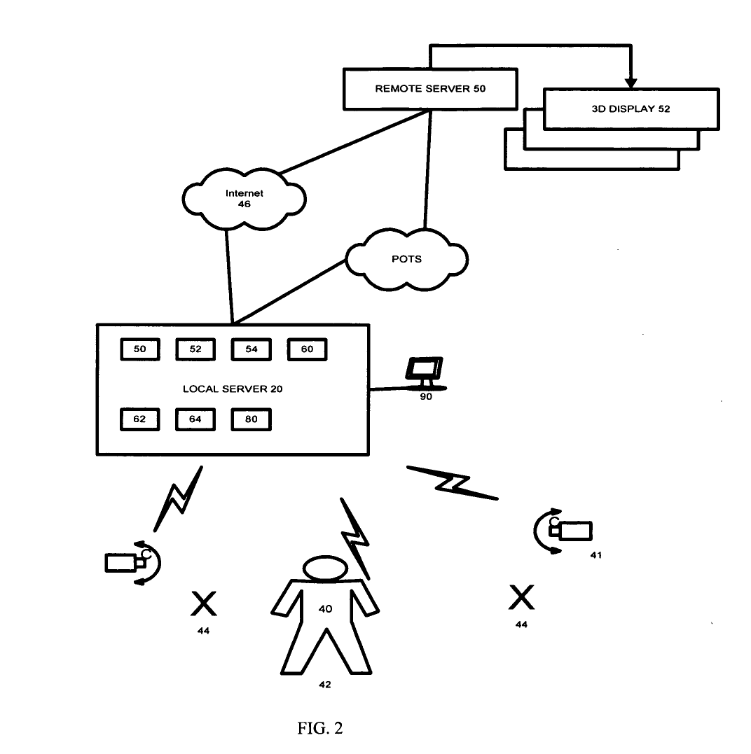

FIG. 2 shows an exemplary system for displaying 3D views. The system includes cameras 41 to capture one or more views of a scene such as a conferee 40 and one or more registration marks 44. The camera provides data to a local processor (not shown) connected to a network 46 to transmit each view in a separate data stream to a remote location. A remote processor 50 receives each data stream at the remote location and generates from the data streams a plurality of images corresponding to the plurality of views. The processor 50 drives a display device 52. The display device 52 has one or more display planes, each display plane rendering an image generated by the processor. Each plane is aligned with the other planes based on the registration marks.

The display device can be one or more projectors projecting light onto the screen. Each projector can be motorized to provide moving projection. A motor drives each projector to allow images to be projected in a sweeping motion. The corresponding cameras at the transmitting location are also motorized. In another embodiment, a motor can be provided to move each display plane. Sensors attached to a viewer provides viewing coordinates to the local computer, and the viewing coordinates are used to move the motors driving the respective cameras.

In one embodiment, the display device includes a plurality of retro-reflective layers. Retro-reflective projection screen material such as that sold under the name SCOTCHLITE® has a reflection characteristic such that what light is reflected by the screen is reflected back closely along the line of incidence and reflected light is brightest on the line of incidence, falling in intensity rapidly as the eye is displaced from the line of incidence in any direction.

The cameras 41 can be wired or wireless. For example, the cameras can communicate over infrared links or over radio links conforming to the 802.11X (e.g. 802.11A, 802.11B, 802.11G) standard or the Bluetooth standard to a local computer or server 20. The server 20 stores images and videos. The user may wear one or more sensors such as a position sensor (GPS). In one embodiment, the sensors are mounted on the user's wrist (such as a wristwatch sensor) and other convenient anatomical locations. The case may be of a number of variations of shape but can be conveniently made a rectangular, approaching a box-like configuration. The wrist-band can be an expansion band or a wristwatch strap of plastic, leather or woven material. The wrist-band further contains an antenna for transmitting or receiving radio frequency signals. The wristband and the antenna inside the band are mechanically coupled to the top and bottom sides of the wrist-watch housing. Further, the antenna is electrically coupled to a radio frequency transmitter and receiver for wireless communications with another computer or another user. Although a wrist-band is disclosed, a number of substitutes may be used, including a belt, a ring holder, a brace, or a bracelet, among other suitable substitutes known to one skilled in the art. The housing contains the processor and associated peripherals to provide the human-machine interface. A display is located on the front section of the housing. A speaker, a microphone, and a plurality of push-button switches and are also located on the front section of housing. An infrared LED transmitter and an infrared LED receiver are positioned on the right side of housing to enable the watch to communicate with another computer using infrared transmission.

In another embodiment, the sensors are mounted on the user's clothing. For example, sensors can be woven into a single-piece garment (an undershirt) on a weaving machine. A plastic optical fiber can be integrated into the structure during the fabric production process without any discontinuities at the armhole or the seams. In another embodiment, instead of being mounted on the user, the sensors can be mounted on fixed surfaces such as walls or tables, for example. One such sensor is a motion detector. Another sensor is a proximity sensor. The fixed sensors can operate alone or in conjunction with the cameras 41. In one embodiment where the motion detector operates with the cameras 41, the motion detector can be used to trigger camera recording.

The server 20 also executes one or more software modules 50-80 to analyze movement data from the user and to compress the video stream from the cameras 41. In the 3D detection process, by putting 3 or more known coordinate objects in a scene, camera origin, view direction and up vector can be calculated and the 3D space that each camera views can be defined. In one embodiment with two or more cameras, camera parameters (e.g. field of view) are preset to fixed numbers. Each pixel from each camera maps to a cone space. The system identifies one or more 3D feature points (such as a birthmark or an identifiable body landmark) on the user. The 3D feature point can be detected by identifying the same point from two or more different angles. By determining the intersection for the two or more cones, the system determines the position of the feature point. The above process can be extended to certain feature curves and surfaces, e.g. straight lines, arcs; flat surfaces, cylindrical surfaces. Thus, the system can detect curves if a feature curve is known as a straight line or arc. Additionally, the system can detect surfaces if a feature surface is known as a flat or cylindrical surface. The further the user is from the camera, the lower the accuracy of the feature point determination. Also, the presence of more cameras would lead to more correlation data for increased accuracy in feature point determination. When correlated feature points, curves and surfaces are detected, the remaining surfaces are detected by texture matching and shading changes. Predetermined constraints are applied based on silhouette curves from different views. A different constraint can be applied when one part of the user is occluded by another object. Further, as the system knows what basic organic shape it is detecting, the basic profile can be applied and adjusted in the process.

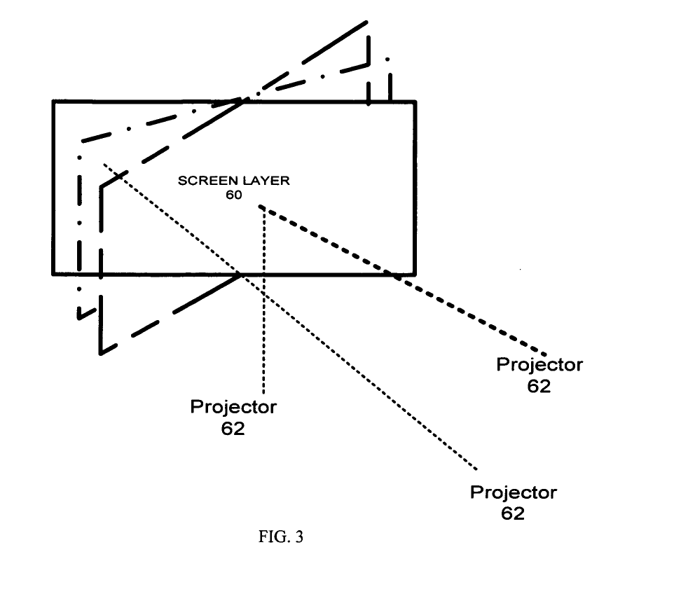

In one implementation shown in FIG. 3, a plurality of transparent retro-reflective layers 60 are angularly interspersed in a screen. Each reflective layer 60 is angularly separated from its neighbor and reflects lights from a corresponding projector 62. Various transparent retro-reflective materials can be used. For example, as discussed in U.S. Pat. No. 6,274,221, the content of which is incorporated by reference, a transparent retroreflective film includes a polymer having an ordered array of integrally formed, interconnected, retroreflecting elements of substantially common shape the film, redirects light towards its originating source with high efficiency due to total internal reflection of light falling on the retroreflecting elements. The microprismatic retroreflective film or sheeting is made with a transparent semicrystalline polymer. The semicrystalline polymer is a syndiotactic vinyl aromatic polymer such as a syndiotactic vinyl aromatic polymer having at least 80% by weight of styrene moieties or a syndiotactic polystyrene copolymer. The microprismatic retroreflective film or sheeting can be a transparent semicrystalline polymer with a syndiotactic vinyl aromatic polymer comprising at least 80% by weight of styrene moieties and with at least 5% by weight of para-methylstyrene moieties.

The film layer can be motorized and cycled to provide depth. In one implementation, a projector projects digital maps of holograms through a digital micromirror device (DMD) available from Texas Instruments. The DMD is illuminated by a laser, and the laser beam from the DMD is projected onto the motorized retro-reflective film layers. In this embodiment, an actuator such as a motor or a latch shifts each film layer on a sequential basis so that the incident laser beam from the projector is sequentially shown on successive retro-reflective film layers to show difference slices of the 3D image being rendered. In one embodiment, 256 layers are cycled at 100 millisecond intervals to provide depth to the 3D image.

In another embodiment, the display device includes a plurality of liquid crystal display (LCD) layers. The LCD layers are transparent, so they can be angularly interspersed inside a single screen in the same manner as shown in FIG. 3.

In another embodiment where the LCD layers are linearly interspersed, the projector can project digital maps of holograms through a digital micromirror device (DMD) available from Texas Instruments. The DMD is illuminated by a laser, and the laser beam from the DMD is projected onto the LCD layers. The LCD layers are sequenced to turn on and off to show difference slices of the 3D image being rendered. In one embodiment, 32 LCD layers are linearly spaced apart and are cycled at 500 millisecond intervals

In yet another embodiment, the display device projects the views onto air, mist or vapor. In this embodiment, a plurality of fluid pipes are spaced apart to be angularly interspersed and the fluid pipes can be turned on or off by the processor. When turned on, fluid such as water is ejected from outlets on the fluid pipes as a sheet of fluid where light can be projected onto. The fluid pipes are sequenced rapidly so that each image corresponding to each view is projected to a corresponding air/mist/vapor sheet from a corresponding pipe.

In another embodiment where the fluid pipes are linearly interspersed, the projector can project digital maps of holograms through a digital micromirror device (DMD) available from Texas Instruments. The DMD is illuminated by a laser, and the laser beam from the DMD is projected onto the fluid pipes. The fluid pipes are sequenced to turn on and off to show difference slices of the 3D image being rendered. In one embodiment, 32 fluid pipes are linearly spaced apart and are cycled at 500 millisecond intervals

In another embodiment, a plurality of microphones are deployed at various spots to capture sounds. Sound captured by the microphones are digitized, compressed and transmitted to the remote location, where the remote processor converts the digital data back into sound to be played on a plurality of speakers at the remote location.

In yet another embodiment, two transparent retro-reflective layers are angularly interspersed in a screen. Each reflective layer is angularly separated from its neighbor and reflects lights from a corresponding projector. Additionally, each reflective layer includes a layer of polarizing material. A viewer wearing polarizing glasses gets a full resolution image for each eye.

In yet another embodiment, small slits are provided on the screen so that temperature controlled air can be directed at the viewer. The temperature control is sent as part of the video stream. Alternatively, a local computer analyzes the images and determines whether hot or cold air is to be streamed. For instance, if the scene is a tropical scene, warm or hot breeze can be directed at the viewer. Alternatively, for winter scenes, cold air can be streamed at the viewer. The air can be directed from behind or alternatively from the user's side. Air can be directed from the front to the back, the back to the front, left to right, or right to left, or any combination thereof. Similarly, the viewer's seat temperature can be controlled to customize the viewing experience. The seat can also be moved in 3D space and can vibrate to provide illusions of movement.

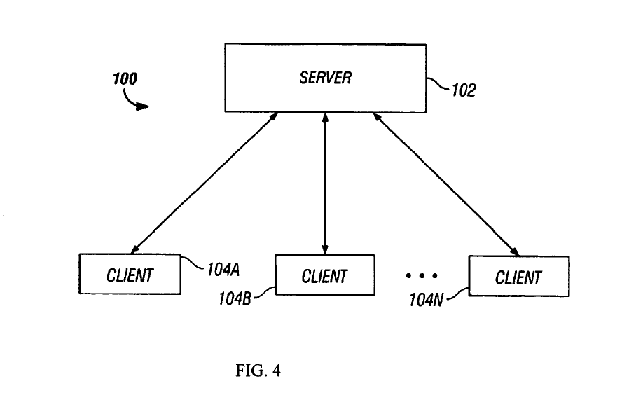

The display system can used in various applications, ranging from 3D television, virtual reality, 3D modeling and simulation, Internet applications, industrial inspection, vehicle navigation, robotics and tele-operation, to medical imaging, dental measurement, apparel and footwear industries, or video conferencing applications, among others. FIG. 4 depicts a plurality of clients 104 engaged in a 3D video conference using a server 102. Each client includes an operating system, such as Windows and a document sharing application. Client 104A has assumed the role of a presenter, and so includes an authoring application that is associated with the document to be shared. For example, the authoring application can be Microsoft Word, and the document to be shared can be a Microsoft Word document. In one embodiment, the Applet is configured as a browser plug-in that can be downloaded from the Internet and installed on a computer running a Windows-type operating system and a browser such as Windows Internet Explorer.

The client 104A can generate one or more applications or Applets for use during the web conference. The client 104A then invites conferees 104B . . . 104N to conference over the web. During the presentation, the client 104A shares the Applets with the conferees 104B . . . 104N. The conferees can view the Applets and also participate in the questions or surveys, if applicable. The results are collected and sent back to the server 102 for tabulation and viewing by the client 104A. If necessary, the client 104A can issue corrective actions based on the tabulation. The client 104A can also provide the address or URL of the Applets for the conferees 104B . . . 104N to download and view after the conference call.

By way of example, a block diagram of a client computer running the Applet is discussed next. Computer preferably includes a processor, random access memory (RAM), a program memory (preferably a writable read-only memory (ROM) such as a flash ROM) and an input/output (I/O) controller coupled by a CPU bus. Computer may optionally include a hard drive controller which is coupled to a hard disk and CPU bus. The programmable processing system may be preprogrammed or it may be programmed (and reprogrammed) by downloading a program from another source (e.g., a floppy disk, CD-ROM, or another computer). Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display such as the display of FIG. 1, a keyboard and a pointing device (mouse) may also be connected to I/O bus. Alternatively, separate connections (separate buses) may be used for I/O interface, display, keyboard and pointing device. Other user input devices such as a trackball, touch-screen, digitizing tablet, etc. can be used. In general, the computer system is illustrative of but one type of computer system, such as a desktop computer, suitable for use with the present invention.

The computers can be configured with many different hardware components and can be made in many dimensions and styles (e.g., laptop, palmtop, pentop, server, workstation, mainframe). Any hardware platform suitable for performing the processing described herein is suitable for use with the present invention. Note that the concepts of “client” and “server,” as used in this application and the industry, are very loosely defined and, in fact, are not fixed with respect to machines or software processes executing on the machines. Typically, a server is a machine or process that is providing information to another machine or process, i.e., the “client,” that requests the information. In this respect, a computer or process can be acting as a client at one point in time (because it is requesting information) and can be acting as a server at another point in time (because it is providing information). Some computers are consistently referred to as “servers” because they usually act as a repository for a large amount of information that is often requested. For example, a World Wide Web (WWW, or simply, “Web”) site is often hosted by a server computer with a large storage capacity, high-speed processor and Internet link having the ability to handle many high-bandwidth communication lines.

A server machine will most likely not be manually operated by a human user on a continual basis, but, instead, has software for constantly, and automatically, responding to information requests. On the other hand, some machines, such as desktop computers, are typically thought of as client machines because they are primarily used to obtain information from the Internet for a user operating the machine.

Depending on the specific software executing at any point in time on these machines, the machine may actually be performing the role of a client or server, as the need may be. For example, a user's desktop computer can provide information to another desktop computer. Or a server may directly communicate with another server computer. Sometimes this is characterized as “peer-to-peer,” communication. Although processes of the present invention, and the hardware executing the processes, may be characterized by language common to a discussion of the Internet (e.g., “client,” “server,” “peer”) it should be apparent that software of the present invention can execute on any type of suitable hardware including networks other than the Internet.

In view of the discussion above, it should be apparent that the system provides many controls and features to allow an author to easily share an effective presentation over a web-conferencing call. Any software application that generates visual information is susceptible for use with the present invention. Further, the invention can be used to make presentations of other information that is not, necessarily, generated from an application program. An example is where images are being viewed in a viewer, such as a web browser. Or a web browser can be used to view web pages that are captured and made into a presentation. Operating system displays, such as file hierarchies, desktop views, etc., can be captured and formed into a presentation with the present invention. Digital video, such as streaming video, can also be captured, annotated and presented. Other images displayed on a computer can be subject matter for a presentation prepared by the authoring interface and tools of the present invention.

Although software of the present invention may be presented as a single entity, such software is readily able to be executed on multiple machines. That is, there may be multiple instances of a given software program, a single program may be executing on two or more processors in a distributed processing environment, parts of a single program may be executing on different physical machines, etc. Further, two different programs, such as a client and server program, can be executing in a single machine, or in different machines. A single program can be operating as a client for one information transaction and as a server for a different information transaction. Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

Portions of the system and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

The system has been described in terms of specific examples which are illustrative only and are not to be construed as limiting. In addition to software, the system may be implemented in digital electronic circuitry or in computer hardware, firmware, software, or in combinations of them. Apparatus of the invention may be implemented in a computer program product tangibly embodied in a machine-readable storage device for execution by a computer processor; and method steps of the invention may be performed by a computer processor executing a program to perform functions of the invention by operating on input data and generating output. Suitable processors include, by way of example, both general and special purpose microprocessors. Storage devices suitable for tangibly embodying computer program instructions include all forms of non-volatile memory including, but not limited to: semiconductor memory devices such as EPROM, EEPROM, and flash devices; magnetic disks (fixed, floppy, and removable); other magnetic media such as tape; optical media such as CD-ROM disks; and magneto-optic devices. Any of the foregoing may be supplemented by, or incorporated in, specially-designed application-specific integrated circuits (ASICs) or suitably programmed field programmable gate arrays (FPGAs).

The present invention has been described in terms of specific embodiments, which are illustrative of the invention and not to be construed as limiting. Other embodiments are within the scope of the following claims. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention.

What is claimed is:

1. An apparatus for displaying three-dimensional images, comprising:
one or more cameras to capture one or more views of a scene and one or more registration marks;
a network to transmit each view in a separate data stream to a remote location;
a processor to receive each data stream at the remote location and generate from the data streams a plurality of images corresponding to the plurality of views; and
a display device coupled to the processor, the display device having one or more display planes aligned based on the registration marks, each display plane rendering an image generated by the processor.

2. The apparatus of claim 1, wherein the display device comprises a plurality of liquid crystal display (LCD) layer.

3. The apparatus of claim 1, wherein the display device comprises a plurality of retro-reflective layers.

4. The apparatus of claim 3, wherein the retro-reflective layers are angularly interspersed in a screen.

5. The apparatus of claim 1, wherein the display device projects the views onto air, mist or vapor.

6. The apparatus of claim 1, comprising a plurality of microphones to capture sounds.

7. The apparatus of claim 1, comprising a plurality of speakers at the remote location.

8. The apparatus of claim 1, wherein the display device comprises one or more projectors.

9. The apparatus of claim 8, comprising a motor coupled to each projector.

10. The apparatus of claim 1, comprising a motor to move each camera.

11. A method for performing three-dimensional video conferencing, comprising:
capturing one or more registration marks;
capturing a plurality of views of a scene;
transmitting each view in a separate data stream to a remote location;
receiving each data stream at the remote location and generating a plurality of images from the data streams;
aligning one or more display planes in accordance with the one or more registration marks; and
projecting the plurality of images onto one or more aligned display planes to show the 3D view of the scene at the remote location.

12. The method of claim 11, comprising: projecting the views onto a plurality of liquid crystal display (LCD) layer.

13. The method of claim 11, comprising: projecting the views onto a plurality of retro-reflective layers.

14. The method of claim 13, wherein the retro-reflective layers are interspersed in a screen.

15. The method of claim 11, comprising projecting the views onto air, mist or vapor.

16. The method of claim 11, comprising capturing sounds with a plurality of microphones.

17. The method of claim 16, wherein the microphones comprise a phased-array of microphones.

18. The method of claim 11, comprising playing sounds at the remote location with a plurality of speakers.

19. The method of claim 18, wherein the speakers comprise a phased-array of speakers.

20. The method of claim 11, wherein projecting the views comprises emitting light from a micro-mirror projector.
